(19) United States
(12) Patent Application Publication
(10) Pub. No.: US 2002/0103767 A1
(43) Pub. Date: Aug. 1, 2002

(54) Transaction and logistics integrated management system (TALISMAN) for secure credit card payment and verified transaction delivery

(75) Inventor: Michael Bournat, Kent (GB)

Correspondence Address: SAUL EWING LLP, CENTRE SQUARE WEST, 1500 MARKET STREET, 38TH FLOOR, PHILADELPHIA, PA, 19102-2186, US

(73) Assignee: CQR Technologies Limited

(21) Appl. No.: 10/026,349

(22) Filed: Dec. 23, 2001

Related U.S. Application Data
(60) Provisional application No. 60/257,748, filed on Dec. 22, 2000.

(51) Int. Cl. G06F 17/60

(52) U.S. Cl. 705/75

(57) ABSTRACT

The present invention is a transaction and logistics integrated management system (TALISMAN) for secure credit card payment and verified transaction delivery.

### RELATED APPLICATIONS

This application claims the benefit of copending U.S. Provisional Application No. 60/257,748, filed Dec. 22, 2000, and copending U.S. Provisional Application No. (Not Yet Assigned), titled Detailed Design Document using Object Oriented Methodology for Talisman, filed Dec. 23, 2001, which are both incorporated here by reference.

### FIELD OF THE INVENTION

The present invention is a transaction and logistics integrated management system (TALISMAN) for secure credit card payment and verified transaction delivery.

### BACKGROUND OF THE INVENTION

There is constant unsolved need for security and verification of commercial transactions and purchasing by consumers ordering goods by telephone and mail (known as “MOTO”—mail order/telephone order), and, in particular, over the Internet (“e-commerce”). Present ordering methods and systems have not and can not meet today's security needs secure, verified transactions. In particular, there is a growing unsolved need for secure and verified delivery of goods and services right to the consumer's door.

Unfortunately, reality shows that the described purchasing process does indeed bear risks as it has resulted in escalating levels of misuse and fraud. This misuse and fraud is originated from both the unlawful use of corruptly obtained credit card details and merchants who set up sites with the intention of obtaining money but not supplying the goods (merchant fraud).

Whether you are a consumer, merchant, acquirer or issuer you might have to face the costly and unpleasant effects of misuse and fraud in the CNP (Cardholder-Not-Present) transaction environment. As a consumer your card is debited before you receive the ordered goods and there is a strong chance that you will receive wrong or faulty goods or, in the worst case, none at all. The merchant can suffer from the use of a stolen, lost or replica (“skimmed”) card whereas banks ultimately stand the losses when the merchant fails or disappears.

The present invention has been designed with the aim to protect all participants: the honest consumer, the honest merchant, the acquirer and the issuer. Though the whole CNP (Cardholder-Not-Present) system is fraught with dangers and possible losses. The present invention produced by CQR Technologies Ltd. is called TALISMAN (transaction and logistics integrated management system) and it addresses the undeniable advantages incorporated in this contemporary way of purchasing. TALISMAN improves the existing banking and credit card clearing system by satisfying the needs of security and protection need for today's consumer market.

The TALISMAN is designed to filly integrate and manage a CNP transaction from the outset to the complete authenticated delivery by a CQR enabled professional logistics company—before the merchant can claim the funds. Equally, will ensure that a consumer cannot deny delivery of the goods. Full adoption of the system will virtually eliminate costly charge backs, repudiation and fraud.

TALISMAN is designed to work with AVS, CVV2, CVC2, CV2 (card security code), PKI, EMV, UKIS and electronic signatures obtained by the logistics company. The interface to the banking environment meets all current banking standards and therefore requires minimal changes to existing operating methods. Modes of payment of the 21st century are highly developed. Now, security is no longer behind. By combining and furthermore managing all links involved in the CNP transaction chain CQR Technologies, consumers, acquirer and issuer banks will only benefit from the true end-to-end solution provide by the present invention.

### SUMMARY OF THE INVENTION

The present invention is a transaction and logistics integrated management system (TALISMAN) for secure credit card payment and verified transaction delivery.

In one embodiment of the present invention the TALISMAN system includes a customer ordering sub-system and a communication system such as, but not limited to, an internet connection. The communication system such as the internet provides communication with and between, a merchant sub-system, an acquirer processing sub-system, a credit card issuer processing sub-system, and a carrier verification and delivery sub-system.

Customers, wanting to purchase goods or services remotely when not present at the site of commerce, utilize the customer ordering sub-system. The customer ordering sub-system is in communication with the merchant sub-system, to make credit card purchases with merchants. Upon request for a purchase, the merchant sub-system requests an authorization for payment and/or an ID tag for each credit card purchase. Authorization for each credit card purchase is issued by the credit card issuer processing sub-system and the authorization is provided to the merchant sub-system through either the acquirer processing sub-system or the carrier verification and delivery sub-system. The ID tag for each credit card purchase is provided by the carrier verification and delivery sub-system and is used at the point of delivery to verify the credit card purchase and to establish proof of delivery at the time of delivery.

In another embodiment of the present invention the TALISMAN system includes a customer ordering sub-system and an internet connection. The Internet connection provides communication with and between a merchant sub-system, an acquirer processing sub-system, a credit card issuer processing sub-system, and a carrier verification and delivery sub-system. The customers use the customer ordering sub-system, which is in communication with the merchant sub-system, to make credit card purchases with merchants.

The merchant sub-system requests an authorization and/or an ID tag from the credit card issuer processing sub-system for each credit card purchase. Authorization for each credit card purchases is issued by the credit card issuer processing system and is provided to the merchant sub-system through either the acquirer processing sub-system or the carrier verification delivery sub-system.

Payment funds are reserved for the purchase by the credit card issuer processing sub-system or the acquirer processing sub-system until verification. The ID tag is issued by the carrier verification and delivery sub-system is used to verify proof of delivery and the credit card purchase at the point of delivery. Upon verification of the delivery and the purchase the reserved funds are released to the merchants.

In another embodiment of the present invention the TALISMAN system includes a customer ordering sub-system and a communication connection, such as an internet or intranet, providing communication with and between a merchant sub-system, an acquirer processing sub-system, a credit card issuer processing sub-system, and a carrier verification and delivery sub-system. Customers use the customer ordering sub-system, which is in communication with the merchant sub-system, to make credit card purchases with merchants.

The merchant sub-system requests an authorization code for each credit card purchase. The authorization code (Auth) for each credit card purchases is issued by the credit card issuer processing system. The Auth is provided to the merchant sub-system through either the acquirer processing sub-system or the carrier verification and delivery sub-system. The authorization code is used to verify delivery and the credit card purchase at the point of delivery. Upon verification of the delivery the purchase funds are released to merchants.

In another embodiment of the present invention the TALISMAN system provides an improvement over prior art systems used for credit card holder not present (CNP) transactions. The prior art system allow a purchasing party to request a purchase from a merchant and delivery of ordered product to a receiving party. An acquiring bank makes a request for authorization for a CNP transaction to a card issuer bank.

The improvement includes an electronic authorization ID issued by the issuer bank and/or the acquirer bank and/or a third party. The third party is a logistic entity that coordinates delivery of goods or services purchased, actual delivery, order placement verification, payment instrument verification and the release of reserved payment funds authored for the transaction. A microprocessor is used to verify the issued electronic authorization ID with the identify of the purchasing party and/or the identity of the receiving party and/or the location of delivery at the point of delivery.

In one aspect of the invention the microprocessor is a programmable storage device having the capacity to receive and store credit card authentication data generated by TALISMAN. In another aspect the programmable storage device is a personal digital assistant (PDA) maintained by a carrier delivering the ordered product. The PDA is used to compare the stored credit card authentication with the actual credit card used to initiate the transaction and/or a remote delivery code provided by TALISMAN for remote deliveries.

In another embodiment of the present invention, a method is provided for a transaction and logistics integrated management system (TALISMAN) for secure credit card payment and verified transaction delivery. The method includes the steps of placing a customer order with a merchant using a customer ordering sub-system. Communicating using an internet connection providing communication with and between a merchant sub-system, an acquirer processing sub-system, a credit card issuer processing sub-system, and a carrier verification and delivery sub-system. Customers use the customer ordering sub-system to make credit cardholder not present purchases with merchant in a manner as described above.

In another embodiment of the present invention, a method for a transaction and logistics integrated management system (TALISMAN) for secure credit card payment and verified transaction delivery includes the steps of:

establishing a communication between a first device, a second device, a third device, and a fourth device. Transmitting payment information, corresponding to a payment instrument of a customer, from the first device to the second device;

forwarding payment information to the third device and the fourth device;

receiving the payment information at the third device;

evaluating the payment information based on the payment instrument by the third device;

transmitting approval of the transaction from the third device to the second device;

storing a record of the transaction approval at the fourth device; forwarding approval of the transaction from the second device to the first device;

requesting the payment instrument by the fourth device at the point of delivery;

comparing the payment instrument with the payment information by the fourth device at the point of delivery; and

transmitting approval to release funds to the first by the fourth device, wherein payment is released to the first by the second device using a direct electronic transmission of monetary value from the second device to the first device.

In one aspect of the invention the first device comprises a merchant device, the second device is an acquirer device, the third device is an issuer device, the fourth device is a carrier verification and delivery device, the party is a consumer, and the payment instrument comprises a card issued by an issuer to a consumer. In another aspect of the invention at least one communication linkage uses the Internet Protocol (IP). In another aspect of the invention at least one communication linkage uses the Internet Protocol (IP), the transmission via at least one communication linkage is encrypted, and the payment instrument is a credit card and/or a debit card.

In another embodiment of the present invention, a transaction and logistics integrated management apparatus (TALISMAN) is provided for secure credit card payment and verified transaction delivery.

The apparatus includes logic that establishes communication between a first or merchant device, a second or acquirer device, a third or issuer device, and a fourth or carrier verification and delivery device. The apparatus also includes logic that transmits payment information corresponding to a payment instrument of a party, from the first electronic device to the second electronic device. The apparatus further includes logic that forwards the payment information from the second electronic device to the third electronic device. The apparatus further includes logic that receives the payment information at the third electronic device.

The apparatus further includes logic that evaluates the payment information using the payment instrument by the third electronic device. The apparatus further includes logic that transmits approval of the transaction from the third electronic device to the second and fourth electronic devices. The apparatus further includes logic that stores a record of the transaction approval at the fourth electronic device

The apparatus further includes logic that forwards approval of the transaction from the fourth electronic device to the second electronic device upon verification of the payment instrument with the payment instrument by the fourth electronic device

Payment is released to the merchant device by the acquirer device using logic that directs electronic transmission of monetary value from the acquirer device to the merchant device

Again, in one aspect of the apparatus the first device comprises a merchant device, the second device is an acquirer device, the third device is an issuer device, the fourth device is a carrier verification and delivery device, the party is a consumer, wherein the payment instrument comprises a card issued by an issuer to a consumer.

Also, the apparatus includes at least one communication linkage using the Internet Protocol (IP), and the transmission in at least one communication linkage may be encrypted.

In another embodiment of the invention, the TALISMAN system includes a computer program embodied on a computer-readable medium for executing an electronic transaction between a first device, such as a merchant electronic device, a second device, such as an acquirer device, a third device, such as an issuer electronic device, and a fourth, such as a carrier verification and delivery device.

The computer program includes a code segment that establishes a communication between the first electronic device and the second electronic device. The program also includes a code segment that couples the second, second, third and fourth electronic device via a first communication linkage. And, a code segment that transmits payment information corresponding to a payment instrument of a party, from the first electronic device to the second and third electronic device. And, a code segment that forwards the payment information to the third electronic device. And, a code segment that receives the payment information at the third electronic device.

And, a code segment that evaluates the payment information based on the payment instrument by the third electronic device. And, a code segment that transmits approval of the transaction from the third electronic device to the second and fourth electronic device. And, a code segment that stores a record of the transaction approval at the second electronic device. And, a code segment that forwards approval of the transaction from the fourth electronic device to the second electronic device upon verification of the payment instrument with the payment instrument by the fourth electronic device.

Payment is released to the first (merchant) device by the second (acquirer) device using logic that directs electronic transmission of monetary value from the second (acquirer) device to the first (merchant) device.

### BRIEF DESCRIPTION OF THE DRAWINGS

For the purpose of illustrating the invention, there is shown in the drawings a form, which is presently, preferred; it being understood, however, that this invention is not limited to the precise arrangements and instrumentalities shown.

FIG. 1 illustrates a transaction and logistics integrated management system (TALISMAN) for secure credit card payment and verified transaction delivery according to one embodiment of the present invention.

FIG. 2 illustrates shipping relationships according to the present invention.

FIG. 3 illustrates a shipping document according to the present invention.

FIG. 4 illustrates a potential drop-off loophole according to the present invention.

FIG. 5 illustrates drop-off loopholes according to the present invention.

FIG. 6 illustrates transaction anatomy according to the present invention.

FIG. 7 illustrates a remote shopping process according to the present invention.

FIG. 8 illustrates PKI and message authentication according to the present invention.

FIG. 9 illustrates SDQ key hierarchy according to the present invention.

FIG. 10 illustrates APACS 29,30 and 50 according to the present invention.

FIG. 11 illustrates level 1 DFD- remote shopping service according to the present invention.

FIG. 12 illustrates service interactions according to the present invention.

FIG. 13 illustrates service components according to the present invention.

FIG. 14 illustrates components and interfaces according to the present invention.

FIG. 15 illustrates service financial components according to the present invention.

FIG. 16 interfaces merchant reporting component according to the present invention.

FIG. 17 illustrates remote shopping components and interfaces according to the present invention.

### DETAILED DESCRIPTION OF THE INVENTION

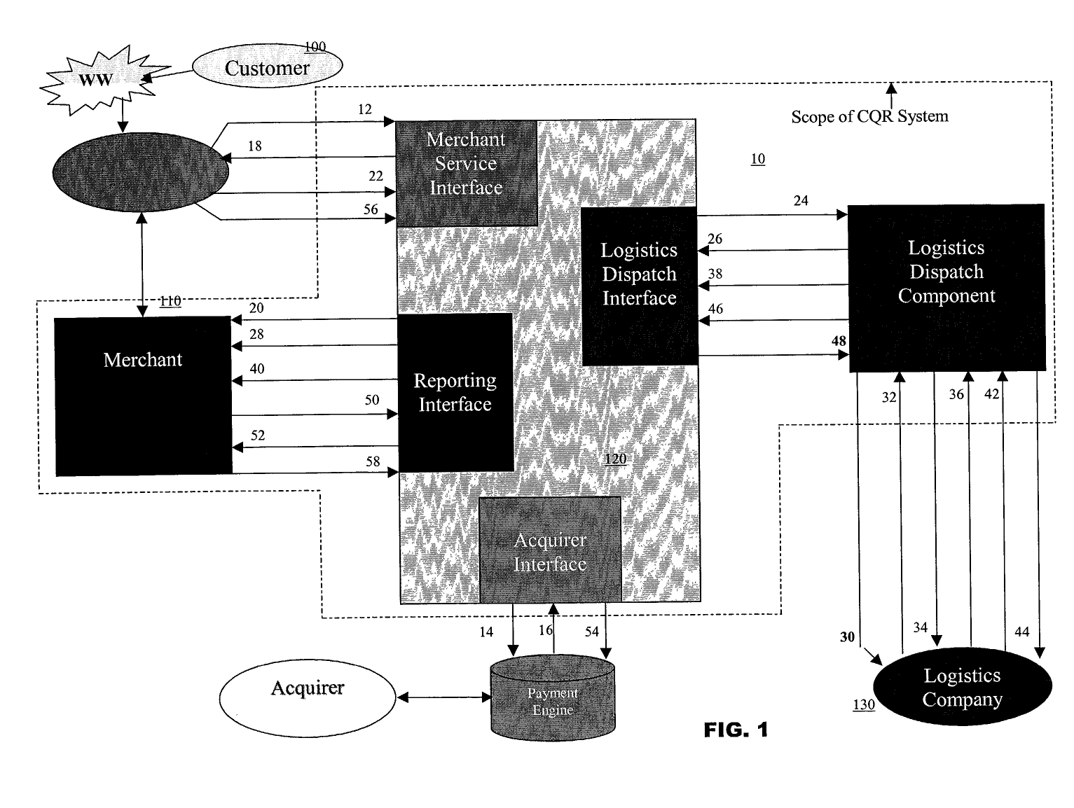

Referring now to the drawings, wherein there is shown in FIGS. 1 through 17 an illustration of the present invention, a transaction and logistics integrated management system (TALISMAN) for secure credit card payment and verified transaction delivery.

CNP Transactions

Cardholder Not Present (CNP) is a banking industry term for remote purchases using a credit or debit card as distinct from a Cardholder Present (CP) transaction when the Cardholder makes a purchase and receives the goods simultaneously. Since the 1970's to the mid-1990's this was a regulated market commonly associated with Mail Order/Telephone Order (MOTO). In the mid 1990's MOTO was joined by Internet (e-Commerce) purchasing which had the result of rapidly increasing the level of CNP purchasing both actual and potential, but without the regulatory framework.

The process of a Credit Card transaction involves the ‘Issuer’ (BarclayCard) providing the ‘Acquirer’ (Barclays Merchant Services) with an authorisation (‘Auth’) that is then passed to the Merchant. A Merchant having received an “Auth” is able to obtain payment without any further form of verification that the goods have been supplied. It therefore follows that, in such an unregulated market, the banks exercise strict control over the approval of Merchants for CNP transactions.

Research with Bank Paribas demonstrated that 40% of all UK businesses are barred from using CNP transactions because of the risk. Research undertaken subsequently shows the figure to be even higher on an International basis. The banks and Schemes (VISA MASTERCARD EUROPAY) all stand to benefit from growth of the CNP business. Security is a huge subject and regularly associated with ‘Fraud’ in the media and by regulatory bodies. This has pawned a growing industry in ‘Public Key Infrastructure (PKI) encryption and ‘firewall’ developments but these are developments of technology without the bedrock of an application providing a viable economic service.

Background to Development of TALISMAN

Credit Card technology was designed 30 years ago and always envisaged that the cardholder would be present when a transaction was made. The parties to a conventional Credit Card transaction are:

The Merchant and his bank (known as the Acquiring bank)

The Consumer and his bank (known as the Issuing bank)

In a transaction the Merchant takes the Credit Card details and seeks authorization from the Issuing bank or a bank payment services provider. The Issuing bank or services provider authorizes the transaction, the Consumer's account is debited and the money passes (less fees) from the Issuing bank to the Merchant's account via the acquiring bank. In a “CNP” transaction (for example a mail order or e-Commerce transaction) the same process is undertaken on authorization of the Credit Card, but on this occasion the Consumer does not have the goods.

The acquiring bank is, nevertheless, obliged by contract to pay the Merchant. Hopefully the correct goods, of satisfactory quality, will be delivered to the Consumer. If they are rejected, or if the Merchant defaults, the Consumer may claim the amount paid for the goods from the Issuing bank (commonly known as a “charge-back”) under the terms of the Consumer Credit Act (Section 75). As a result of banks' concerns over fraud, payment service providers (PSP) have developed which charge Merchants for authorising Credit Cards in the CNP environment. The Issuing banks, however, remain ultimately responsible for Consumer charge-backs.

Weaknesses in a CNP Transaction

There is no mechanism to ensure the Consumer receives the goods ordered.

A Merchant can obtain funds from the acquiring bank prior to supplying any goods.

A Consumer card account can charged before receipt of goods.

The credit/debit card details may have been obtained fraudulently.

The Merchant may use Credit Card details fraudulently to make multiple purchases.

The Consumer may never receive the goods (whether as a result of fraud or otherwise).

The Acquiring bank will lose in a ‘charge-back’ if the Merchant defaults (liquidation/receivership).

The Issuing bank loses if a stolen or lost or skimmed card is used fraudulently.

The Merchant loses if the goods are intercepted or the Consumer ‘repudiates’ the delivery. Without TALISMAN, the risks for all parties to the CNP transaction are extremely high. When mail order was the principal type of CNP transaction the risk was limited and manageable. With the onset of e-Commerce, CNP transactions rapidly escalated and the Credit Card companies recognised they were exposed to increasing levels of fraud risk. As a result they sought to reduce the risk whilst taking full advantage of the revenue opportunities represented by e-Commerce.

TALISMAN is the first end-to-end solution for cardholder-not-present credit-card transactions that protects all parties in the credit-card payment scheme: Banks, Consumers and Merchants. The unique TALISMAN process provides acquiring banks with the ability to ensure that payment is only released to Merchants when the cardholder has received the goods. TALISMAN provides a verifiable link between the original order and the receipt of goods; this reduces the ability of a Consumer to deny receipt of the goods and demand fraudulent refunds. By using TALISMAN, payment is released to Merchants only after the customer receives the goods, thus eliminating Merchants fraudulently billing acquiring banks for goods that do not exist or have never been delivered.

Since Merchant payments are released only when goods are received, credit guarantee requirements on accepting new Merchants are greatly reduced, allowing smaller Merchants to join the credit-card scheme, and expanding the card market itself to the major benefit of the banks.

Minimising Banks' Exposure to Fraudulent Consumers

It is a fact that the incidence of Consumers fraudulently claiming refunds on the basis of non-delivery of goods is constantly growing. By implementing TALISMAN, both Merchants and credit-card companies can verify delivery and significantly reduce fraudulent Consumer claims, diminishing the cost of charge-backs.

Minimising Banks' Exposure to Fraudulent Merchants

If no authenticated delivery can be provided, TALISMAN will not authenticate the transaction and the funds will remain within the banking system, eliminating the possibility for fraudulent Merchant claims. With TALISMAN, Merchants selling non-existent goods or claiming fictitious sales will not be able to receive payment.

The TALISMAN Process

A Consumer with a SMART credit-card orders goods from a Merchant. The SMART card details are processed using a Secure Socket Layer via the scheme to the Issuing bank. The Consumer validates the card by entering his unique SMART PIN number to confirm the order. An authorisation code (“Auth”) and funds are obtained from the issuing bank, (debiting the cardholder's account) and the funds are passed into a holding account with the Acquiring bank.

The TALISMAN system gives the transaction a unique tracking identification number. The Merchant advises a TALISMAN equipped carrier of the transaction and the goods are collected. At the point of delivery the cardholder presents his SMART card, which is inserted into a PDA that is loaded with TALISMAN software, and authentication takes place. The card reader (“PDA”) validates the card and, upon validation, the cardholder is required to enter his unique SMART PIN number. Provided the card validates the PIN number the transaction is confirmed. The goods are then released to the cardholder. At the end of each period, all TALISMAN Proofs of Delivery are downloaded to the Carrier's database, which in turn batch-transfers completed transactions to the TALISMAN data centre. The TALISMAN data centre matches the authenticated deliveries against transactions on its database and transfers confirmations to the Acquiring bank. Having received authentication, the Acquiring bank releases funds to the Merchant in accordance with its normal terms.

Security Benefits

TALISMAN satisfies and secures all the expectations of the parties to a CNP transaction. The ‘peace of mind’ benefits for each party can be summarised as follows. The Consumer is secure in the knowledge that the Merchant cannot obtain his funds until the Consumer validates the delivery. The bank is secure in the knowledge that, because of validation, there is a significantly reduced chance of repudiation, as only the valid cardholder will know the PIN number of their card. The Merchant bank is secure in the knowledge that funds have been secured on the basis of an authenticated delivery. The logistics business is secure in the knowledge that there is a significantly reduced chance of repudiation of delivery.

Increasing Business Volume

There is a significant additional added benefit derived from the TALISMAN system. Due to the potential losses from fraud and early/new business failure, the banks lay down strict criteria for Merchants to be enabled to take CNP transactions. Although insurance and premium transaction charges exist to service this sector they do not in themselves solve the problem of fraud and losses where money is obtained prior to completion of the transaction. The new Merchant pays a heavy price for early entry and the banks are aware that if they have a viable solution for this sector they are the beneficiaries of substantial additional revenues.

TALISMAN and its authentication process enables the Acquiring bank to release funds only after verified delivery. This means that the approval criteria can be dispensed with. A Merchant cannot obtain funds until he has completed the transaction in which case any Merchant could be enabled to take CNP transactions.

FIG. 1 illustrates one embodiment showing a method 10 for a transaction and logistics integrated management system (TALISMAN) for secure credit card payment and verified transaction delivery according to the present invention.

As shown in FIG. 1, a request is made for a TALISMAN sale 12. A Pre Authorization 14 is requested by the acquiring bank 120 and an Auth Response 16 containing an Auth Code is provided by the issuing bank (not shown). A Merchant Response 18 including a TALISMAN ID is then issued and a Log CQR sale 20 is recorded. A CQR Delivery 22 is initiated containing logistics ID supplied by the merchant 110. The CQR Delivery Register 24 is maintained to track accepted deliveries 26. A transaction status change 28, delivery alert 30, batch ID 32 are also used to facilitate tracking the status monitoring. CQR Consignment Delivery Details 34 are maintained along with CQR Details Accepted 36 and CQR Transaction Status Change 38. The Transaction Status Request 40 is made upon Consignment POD 42 at the point of delivery. Upon Acceptance of POD Details 44 a CQR Point of Delivery 46 is made with Proof of Acceptance 48. A Transaction Status Report 50 is generated along with CQR Delivery Details 52. A Post Authorization Settlement 54 is made upon satisfactory acceptance at the point of delivery or a Cancellation CQR Sale 56 is made should the Proof of Acceptance 48 failed. A Report Acknowledgement 58 is made at the conclusion of the transaction.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A transaction and logistics integrated management system (TALISMAN) for secure credit card payment and verified transaction delivery, the system comprising:
a customer ordering sub-system; and
an internet connection providing communication with and between,
a merchant sub-system,
an acquirer processing sub-system,
a credit card issuer processing sub-system, and
a carrier verification and delivery sub-system
wherein, customers use the customer ordering sub-system, which is in communication with the merchant sub-system, to make credit card purchases with merchants, the merchant sub-system requests an authorization and/or an ID tag for each credit card purchase, authorization for each credit card purchases is issued by the credit card issuer processing sub-system and is provided to the merchant subsystem through either the acquirer processing sub-system or the carrier verification and delivery sub-system, the ID tag for each credit card purchase is provided by the carrier verification and delivery sub-system and is used at the point of delivery to verify the credit card purchase and to establish proof of delivery at the time of delivery.

2. A transaction and logistics integrated management system (TALISMAN) for secure credit card payment and verified transaction delivery, the system comprising:
a customer ordering sub-system; and
an internet connection providing communication with and between,
a merchant sub-system,
an acquirer processing sub-system,
a credit card issuer processing sub-system, and
a carrier verification and delivery sub-system
wherein, customers use the customer ordering sub-system, which is in communication with the merchant sub-system, to make credit card purchases with merchants, the merchant sub-system requests an authorization and/or an ID tag from the credit card issuer processing sub-system for each credit card purchase, authorization for each credit card purchases is issued by the credit card issuer processing system and is provided to the merchant sub-system through either the acquirer processing sub-system or the carrier verification and delivery sub-system, funds are reserved for the purchase by the credit card issuer processing sub-system or the acquirer processing sub-system until verification, the ID tag is issued by the carrier verification and delivery sub-system is used to verify proof of delivery and the credit card purchase at the point of delivery, upon verification of the delivery and the purchase, the reserved funds are released to the merchants.

3. A transaction and logistics integrated management system (TALISMAN) for secure credit card payment and verified transaction delivery, the system comprising:
a customer ordering sub-system; and
an internet connection providing communication with and between,
a merchant sub-system,
an acquirer processing sub-system,
a credit card issuer processing sub-system, and
a carrier verification and delivery sub-system
wherein, customers use the customer ordering sub-system, in communication with the merchant sub-system, to make credit card purchases with merchants, the merchant sub-system requests an authorization code for each credit card purchase, the authorization code for each credit card purchases is issued by the credit card issuer processing system and is provided to the merchant sub-system through either the acquirer processing sub-system or the carrier verification and delivery sub-system, the authorization code is used to verify proof of delivery and the credit card purchase at the point of delivery, upon verification of the delivery and the purchase funds are released to merchants.

4. A transaction and logistics integrated management system (TALISMAN) for secure credit card payment and verified transaction delivery, providing an improvement over prior art systems used for credit card holder not present (CNP) transactions, the prior art system having a purchasing party requesting a purchase from a merchant and delivery of ordered product to a receiving party, an acquiring bank requesting authorization for a CNP transaction from a card issuer bank, the improvement comprising:
an electronic authorization ID issued by the issuer bank or the acquirer bank or a third party, and
a microprocessor to compare the issued electronic authorization ID with the identify of the purchasing party and/or the identity of the receiving party at the point of delivery.

5. The system according to claim 4, wherein the microprocessor is a programmable storage device having the capacity to receive and store credit card authentication data generated by TALISMAN.

6. The system according to claim 5, wherein the programmable storage device is a personal digital assistant (PDA) maintained by a carrier delivering the ordered product, wherein the PDA is used to compare the stored credit card authentication with the actual credit card used to initiate the transaction and/or a remote delivery code provided by TALISMAN for remote deliveries.

7. A method for a transaction and logistics integrated management system (TALISMAN) for secure credit card payment and verified transaction delivery, the method comprising the steps of:
placing a customer order with a merchant using a customer ordering sub-system; and
communicating using an internet connection providing communication with and between,
a merchant sub-system,
an acquirer processing sub-system,
a credit card issuer processing sub-system, and
a carrier verification and delivery sub-system
wherein, customers use the customer ordering sub-system, which is in communication with the merchant sub-system, to make credit card purchases with merchants, the merchant sub-system requests an authorization and/or an ID tag for each credit card purchase, authorization for each credit card purchases is issued by the credit card issuer processing sub-system and is provided to the merchant sub-system through either the acquirer processing sub-system or the carrier verification and delivery sub-system, the ID tag for each credit card purchase is provided by the carrier verification and delivery sub-system and is used at the point of delivery to verify the credit card purchase and to establish proof of delivery at the time of delivery.

8. A method for a transaction and logistics integrated management system (TALISMAN) for secure credit card payment and verified transaction delivery, the method comprising the steps of:
establishing a communication between a first (merchant) device, a second (acquirer) device, a third (issuer) device, and a fourth (carrier verification and delivery) device;
transmitting payment information, corresponding to a payment instrument of a customer, from a first (merchant) device to a second (acquirer) device;
forwarding payment information to the third (issuer) device and the fourth (carrier verification and delivery) device;
receiving the payment information at the third (issuer) device;
evaluating the payment information based on the payment instrument by the third (issuer) device;
transmitting approval of the transaction from the third (issuer) device to the second (acquirer) device;
storing a record of the transaction approval at the fourth (carrier verification and delivery) device;
forwarding approval of the transaction from the second (acquirer) device to the first (merchant) device;
requesting the payment instrument by the fourth (carrier verification and delivery) device at the point of delivery;
comparing the payment instrument with the payment information by the fourth (carrier verification and delivery) device at the point of delivery, and
transmitting approval to release funds to the first (merchant device) by the fourth device, wherein payment is released to the first (merchant device) by the second (acquirer) device using a direct electronic transmission of monetary value from the second (acquirer) device to the first (merchant) device.

9. The system according to claim 8, wherein the first device comprises a merchant device, the second device is an acquirer device, the third device is an issuer device, the fourth device is a carrier verification and delivery device, the party is a consumer, wherein the payment instrument comprises a card issued by an issuer to a consumer.

10. The system according to claim 8, wherein at least one communication linkage uses the Internet Protocol (IP).

11. The system according to claim 8, wherein at least one communication linkage uses the Internet Protocol (IP).

12. The system according to claim 1, wherein the transmission via at least one communication linkage is encrypted.

13. The system according to claim 1, wherein the payment instrument is a credit card.

14. The system according to claim 1, wherein the payment instrument is a debit card.

15. A transaction and logistics integrated management apparatus (TALISMAN) for secure credit card payment and verified transaction delivery, the apparatus comprising:
logic that establishes communication between a first (merchant) device, a second (acquirer) device, a third (issuer) device, and a fourth (carrier verification and delivery) device;
logic that transmits payment information corresponding to a payment instrument of a party, from the first electronic device to the second electronic device;
logic that forwards the payment information from the second electronic device to the third electronic device;
logic that receives the payment information at the third electronic device;
logic that evaluates the payment information using the payment instrument by the third electronic device;
logic that transmits approval of the transaction from the third electronic device to the second and fourth electronic devices;
logic that stores a record of the transaction approval at the fourth electronic device;
logic that forwards approval of the transaction from the fourth electronic device to the second electronic device upon verification of the payment instrument with the payment instrument by the fourth electronic device, wherein payment is released to the first (merchant) device by the second (acquirer) device using logic that directs electronic transmission of monetary value from the second (acquirer) device to the first (merchant) device

16. The apparatus according to claim 15, wherein the first device comprises a merchant device, the second device is an acquirer device, the third device is an issuer device, the fourth device is a carrier verification and delivery device, the party is a consumer, wherein the payment instrument comprises a card issued by an issuer to a consumer.

17. The apparatus according to claim 15, wherein at least one communication linkage uses the Internet Protocol (IP).

18. The apparatus according to claim 15, wherein the transmission via at least one communication linkage is encrypted.

19. The apparatus as recited in claim 15, wherein the payment instrument is a credit card.

20. The apparatus as recited in claim 15, wherein the payment instrument is a debit card.

21. A transaction and logistics integrated management system (TALISMAN) for secure credit card payment and verified transaction delivery having a computer program embodied on a computer-readable medium for executing an electronic transaction between a first electronic device, a second electronic device, a third electronic device, and a fourth electronic device, the computer program comprising:
a code segment that establishes a communication between the first electronic device and the second electronic device;
a code segment that couples the second, second, third and fourth electronic device via a first communication linkage;
a code segment that transmits payment information corresponding to a payment instrument of a party, from the first electronic device to the second and third electronic device;
a code segment that forwards the payment information to the third electronic device;
a code segment that receives the payment information at the third electronic device;
a code segment that evaluates the payment information based on the payment instrument by the third electronic device;
a code segment that transmits approval of the transaction from the third electronic device to the second and fourth electronic device;
a code segment that stores a record of the transaction approval at the second electronic device; and
a code segment that forwards approval of the transaction from the fourth electronic device to the second electronic device upon verification of the payment instrument with the payment instrument by the fourth electronic device, wherein payment is released to the first (merchant) device by the second (acquirer) device using logic that directs electronic transmission of monetary value from the second (acquirer) device to the first (merchant) device.

22. The computer program as recited in claim 21 wherein the first electronic device is a consumer device, the second electronic device comprises an acquirer device, the third electronic device comprises an issuer device, the fourth electronic device is a credit card issuer processing sub-system, wherein the payment instrument comprises a card issued by an issuer to a consumer.
